(19) United States
(12) Patent Application Publication
(10) Pub. No.: US 2018/0203194 A1
(43) Pub. Date: Jul. 19, 2018

(54) OPTICAL MODULES

(71) Applicant: Hewlett-Packard Development Company, L.P., Houston, TX (US)

(72) Inventors: Chien-Hua Chen, Corvallis, OR (US); Michael W. Cumbie, Corvallis, OR (US); Devin Alexander Mourey, Corvallis, OR (US)

(73) Assignee: Hewlett-Packard Development Company, L.P., Houston, TX (US)

(21) Appl. No.: 15/750,004

(22) PCT Filed: Aug. 3, 2015
(86) PCT No.: PCT/US2015/043459

§ 371 Date: Feb. 2, 2018

(51) Int. Cl. G02B 6/42; G02B 6/13

(52) U.S. Cl. CPC G02B 6/4255; G02B 6/4269; G02B 6/4204; G02B 6/13; G02B 6/428

(57) ABSTRACT

Optical modules are disclosed. An example method includes coupling optoelectronic components to a carrier substrate; overmolding the optoelectronic components with a material to form a molded panel, a surface of the molded panel to be at least substantially flush; and removing the carrier substrate from the surface.

### BACKGROUND

Some optical circuits (e.g., waveguides) are used as an interface between a printed circuit board and a fiber optic cable. In some instances, optical components are connected to the top of the printed circuit board.

### BRIEF DESCRIPTION OF THE DRAWINGS

FIG. 1 illustrates an example cross-sectional view of an example optical module in accordance with the teachings of this disclosure.

FIG. 2 illustrates a top plan view of the example optical module of FIG. 1.

FIG. 3 illustrates a portion of an example optical module ha can be used to implement the example optical module of FIG. 1.

FIG. 4 illustrates a top plan view of the portion of the example optical module of FIG. 3.

FIG. 5 illustrates a portion of another example optical module including first and second intersecting grooves that can be used to implement the example optical module of FIG. 1.

FIG. 6 is an example flowchart representative of an example method that can be used to produce the example optical modules disclosed herein.

FIG. 7 illustrates an example flow showing example optical module at various stages of processing in accordance with the example methods disclosed herein.

FIG. 8 is another example flowchart representative of another example method that can be used to produce the example optical modules disclosed herein.

FIG. 9 is another example flowchart representative of another example method that can be used to produce the example optical modules disclosed herein.

FIG. 10 is an example processor platform to execute the instructions of FIGS. 6, 7, 8 and 9 to implement an example apparatus to produce the example optical modules disclosed herein.

The figures are not to scale. Wherever possible, the same reference numbers will be used throughout the drawing(s) and accompanying written description to refer to the same or like parts.

### DETAILED DESCRIPTION

At least some of the examples disclosed herein relate to example optical modules including components (e.g., optoelectronic components, a circuit) that are overmolded with epoxy to encapsulate the components, form a molded panel and provide a relatively planar surface. As set forth herein, relatively planer accounts for manufacturing tolerances, refers to surfaces (e.g., top surfaces) of the material and/or the components having surfaces lying within the same plane (e.g., approximately 90% planer) and/or refers to the surfaces being planer (e.g., 100% planer). In some examples, prior to overmolding, the components are disposed on a disposable and/or removable carrier. After the components are overmolded with an epoxy, the carrier may be removed to reveal a relatively planar surface of the molded panel. By encapsulating the components to form the molded panel and/or by using the removable carrier when producing the example optical modules, the examples disclosed herein may exclude the substrate present in some electrical and/or optical circuits. In some examples, the overmolding process forms at least substantially flush surface that facilitates the coupling of optical circuits (e.g., waveguides, integrated waveguides) and/or a redistribution layer (RDL) thereon. As set forth herein, at least substantially flush accounts for manufacturing tolerances, refers to surfaces (e.g., top surfaces) of the material and/or the components directly abutting and/or being immediately adjacent (e.g., approximately 90% flush) and/or refers to the surfaces being flush (e.g., 100% flush).

In some examples, components of the optical module that are overmolded include a light source (e.g., a vertical-cavity surface-emitting laser light source), a driver, a detector (e.g., a gallium arsenide (GaAs) detector), a receptacle(s), a transceiver(s), optoelectronic components, a printed circuit board, a central processing unit, a chip set, etc. Overmolding the components may facilitate (e.g., enable) optoelectronic (OE) components to be connected to the planer surface and reduce the complexity and/or cost of producing such optical modules. Additionally and/or alternatively, with the components at least substantially encapsulated by the overmolding, in some examples, a waveguide(s) may be coupled to and/or built on the planar surface of the optical module. As set forth herein, the phrase at least substantially encapsulated may mean a portion of at least one of the components is not completely surrounded by the overmolding material and/or accounts for manufacturing specifications and/or manufacturing tolerances and/or means that the components are entirely encapsulated. Additionally and/or alternatively, with the components substantially encapsulated by the overmolding, in some examples, the printed circuit board (PCB) and/or the redistribution layer (RDL) may be used as an electrical interconnect to other components. In some examples, to promote heat transfer from the example optical modules, a heat sink may be coupled to a surface of the optical modules opposite the planer surface. Additionally and/or alternatively, in some examples, to promote heat transfer from a component(s) of the optical module, the optical module may define a vent(s) and/or a fluidic channel(s).

In some examples, the optical modules include mating and/or alignment structures configured to efficiently couple light between optical circuits and example optical fibers. In some examples, the alignment structures include grooves (e.g., V-grooves) defined and/or formed in the molded panel to facilitate optical fiber(s) be easily coupled (e.g., mechanically and/or optically coupled, optomechanically coupled) to the molded panel and/or a photonic chip of the optical module. In some examples, mechanical coupling facilitates the optical fiber to be secured within the groove. In some examples, optical coupling facilitates light to be transmitted between two circuits. In some examples optomechanical coupling facilitates an optical circuit being coupled to an electrical circuit.

In some examples, the grooves include a first groove(s) having a first depth and a second groove(s) having a second depth. In examples in which the first and second grooves intersect, the different depths of the grooves facilitates a first optical fiber being coupled and/or aligned at the first groove and a second optical fiber being coupled and/or aligned at the second groove. Thus, using the examples disclosed herein, multiple optical fibers can be coupled to the optical module near the same coupling point(s) and, in some examples, the optical fibers overlay each other at the groove intersections. In some examples, the mating structures and/or an array of mating structures facilitate optical fibers to be passively aligned and/or coupled to the optical modules along different axes (e.g., along the x-axis, along the y-axis, along the z-axis, etc.).

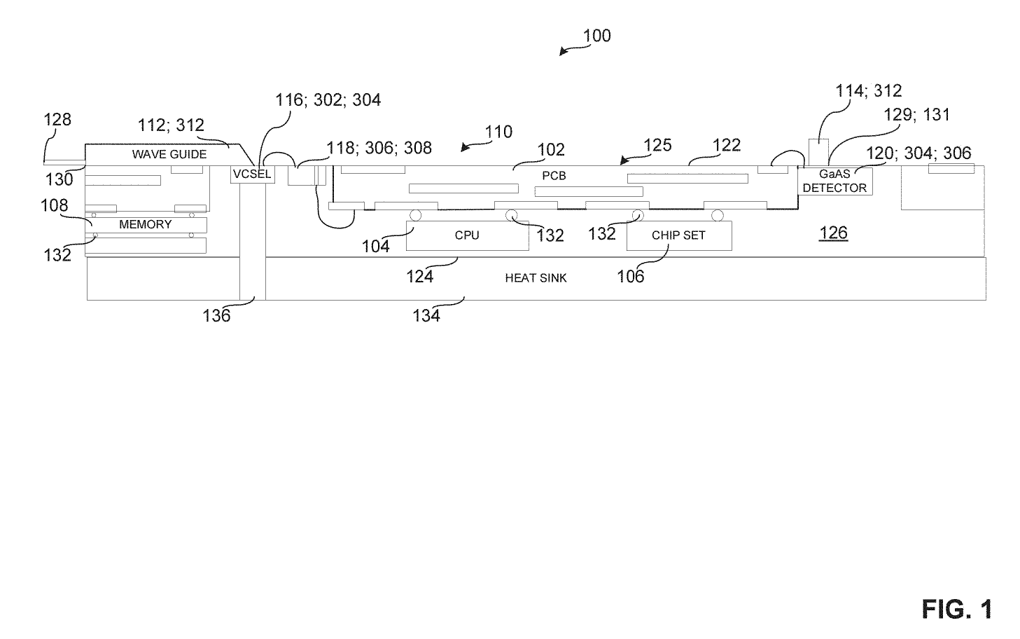

FIG. 1 illustrates an example optical module 100 including a printed circuit board (PCB) 102, a central processing unit (CPU) 104, a chip set 106, a memory 108, optoelectronic (OE) components 110 and first and second waveguides 112, 114 including a turning mirror(s). In this example, the optoelectronic components 110 include a light source (e.g., a vertical cavity surface emitting laser (VCEL)) 116, a driver 118, a detector (e.g., a GaAs detector) 120, etc. Other components may be included.

As shown in the example of FIG. 1, the first waveguide 112 is positioned immediately adjacent and/or on top of the light source 116 and the second waveguide 114 is positioned immediately adjacent and/or on top of the detector 120. The first and/or second waveguides 112, 114 may be fabricated using any suitable fabrication methods such as, for example, integrated circuit fabrication methods.

To facilitate a first surface 122 and/or a second surface 124 of the optical module 100 being relatively planar, in some examples, the printed circuit board (PCB) 102, the central processing unit (CPU) 104, the chip set 106, the memory 108 and the optoelectronic (OE) components 110 or, more generally, a circuit 125, are overmolded with, for example, an overmold material 126. The overmold material 126 may be epoxy or any other suitable material. Thus, as shown in the example of FIG. 1, the PCB 102, the CPU 104, the chip set 106 and/or memory 108 are overmolded (e.g., overmolded on panel level) into a single package in which surfaces of the light source 116, the detector 120, the PCB 102 and/or the overmold material 126 are at least substantially flush and/or opposing surfaces are at least substantially coplanar. As set forth herein, at least substantially coplanar accounts for manufacturing tolerances and/or means that the opposing surfaces within about 3 degrees of coplanar and/or means that the opposing surfaces are coplanar.

In some examples, to facilitate first and second optical fibers 128, 129 being coupled to the first and second waveguides 112, 114, first and second grooves 130, 131 are formed by the overmold material 126 at the first and second waveguide 112, 114. The grooves 130, 131 may have any suitable cross-section, such as, for example, a V-shaped cross-section. In one example, the first groove 130 receives the first optical fiber 128 to couple the first optical fiber 128 to the first waveguide 112, the optical module 100 and/or the light source 116 and the second groove 131 receives the second optical fiber 129 to couple the second optical fiber 129 to the second waveguide 114, the optical module 100 and/or the detector 120. Without limitation, either of the optical fibers 128, 129 may include a single optical fiber, optical fiber arrays, a single multicore optical fiber, multiple multicore optical fibers, or any combination thereof.

In the illustrated example of FIG. 1, solder bumps 132 are used to couple (e.g., electrically couple) the CPU 104 and the PCB 102, to couple (e.g., electrically couple) the chip set 106 and the PCB 102 and to couple (e.g., electrically couple) different portions of the memory 108. In some examples, the optical module 100 includes traces (e.g., electrically conductive through-mold vias (TMVs)) that extend through the overmold material 126 toward the first and/or second surfaces 122, 124 to facilitate the PCB 102, other components of the optical module 100 and/or the optical circuits to be placed in communication with other devices adjacent to the first and/or second surfaces 122, 124 of the optical module 100. Additionally and/or alternatively, in some examples, an electronic redistribution layer is formed on the first and/or second surfaces 122, 124 to facilitate electrical communication between the optical circuit, the optical module 100 and/or other devices on the optical module 100. The other devices may include another integrated circuit, a discrete electronic component, an organic substrate and/or a larger printed circuit board, etc. Additionally or alternatively, traces and/or the electronic redistribution layer may provide electrical communication to optical circuits and/or other devices on the optical module 100.

In the illustrated example of FIG. 1, to cool the components of the optical module 100, a heat sink 134 is coupled to the second surface 124. The example heat sink 134 may be larger and/or smaller than illustrated in FIG. 1. In this example, to facilitate the increased cooling of the light source 116 and/or the components of the optical module 100, an aperture and/or vent 136 is defined through the overmold material 126 and/or the heat sink 134. In some examples, reducing the operating temperature of the light source 116 may increase the power conversion efficiency of the light source 116 and/or increases the useful life of the light source 116. While FIG. 1 shows the optical module 100 including a single cooling aperture, in other examples, the optical module 100 can include more than one cooling aperture.

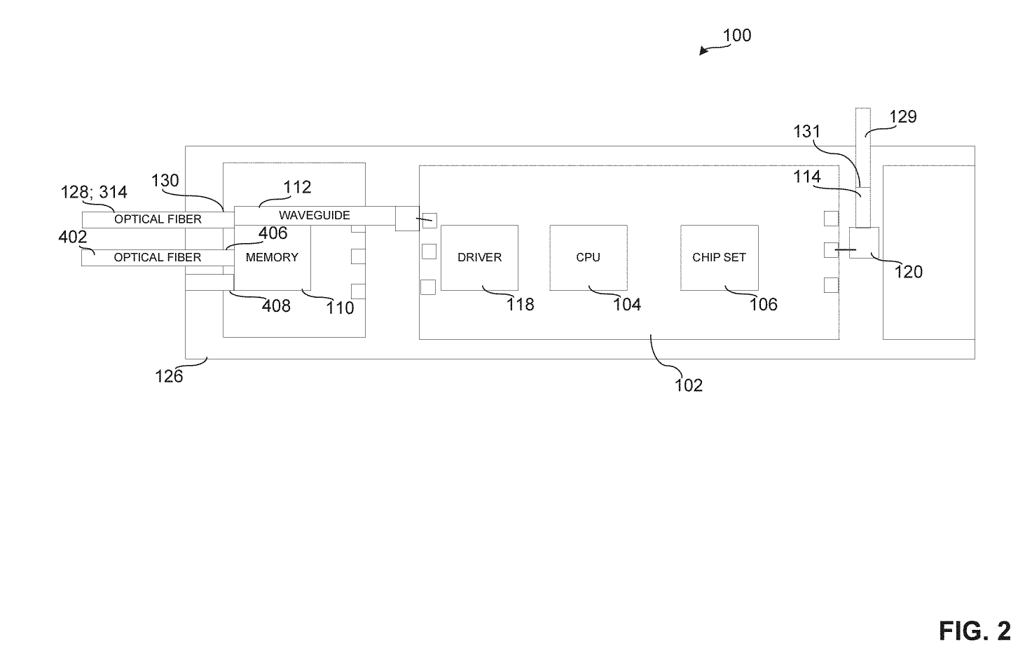

FIG. 2 illustrates a top plan view of the example optical module 100 of FIG. 1. As shown in the example of FIG. 2, the first and second optical fibers 128, 129 are received in respective ones of the first and second grooves 130, 131 to couple the first and second optical fibers 128, 129 and the optical module 100.

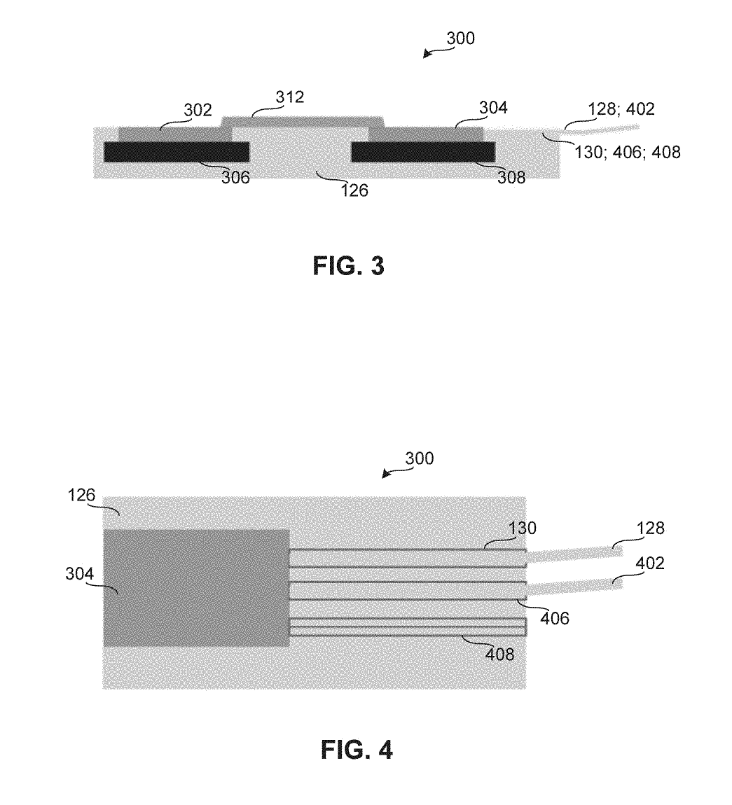

FIG. 3 illustrates a cross-sectional view of a portion of an example optical module 300 that can be used to implement the optical module of FIG. 1. In this example, the optical module 300 includes first and second photonic chips 302, 304 coupled to and/or mounted on respective first and second chips 306, 308. In some examples, the chips 302, 304, 306 and/or 308 are used to implement the optoelectronic components of FIG. 1 such as, for example, the light source 116. In this example, the first and second chips 306, 308 may be application-specific integrated circuits, central processing units, integrated circuits, etc. As shown in the example of FIG. 3, the chips 302, 304, 306, 308 are overmolded using the overmold material 126 to facilitate surfaces of the first and second photonic chips 302, 304 and the overmold material 126 to be substantially flush and/or to facilitate a waveguide 312 to be formed on the flush surface between the photonic chips 302, 304, for example. In some examples, the overmold material is epoxy or any other material.

In this example, to facilitate optical fibers 128, 402 being coupled to the optical module 300 and/or the first and/or second photonic chips 302, 304, first, second and third grooves 130, 406, 408 are formed by the overmold material 126. In some examples, the grooves 130, 406, 408 have a V-shape to facilitate the optical fibers 128, 402 to be relatively easily coupled and/or wedged within the grooves 130, 406, 408.

FIG. 4 is a top plan view that illustrates the coupling between the optical fibers 128, 402, the grooves 130, 406, 408 and the second photonic chip 304. In some examples, the optical module 300 may define any other number of grooves to facilitate any number of optical fibers being coupled to the optical module 300.

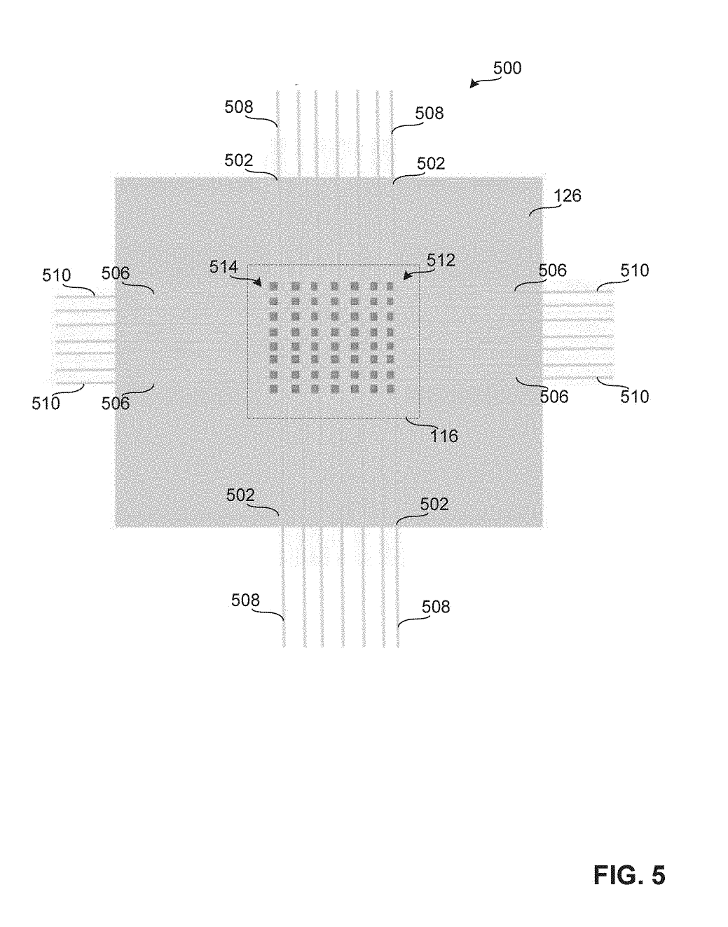

FIG. 5 is a top plan view of a portion of an example optical module 500 that can be used to implement the optical module of FIG. 1. In contrast to the example of FIG. 1, in the example of FIG. 5, the optical module 500 includes first grooves 502 that are defined in the overmold material 126 and second grooves 506 that are defined in the overmold material 126 to facilitate more optical fibers being coupled to the optical module 500. In some examples, to facilitate first optical fibers 508 being coupled to respective ones of the first grooves 502 and for second optical fibers 510 being coupled to respective ones of the second grooves 506, the first grooves 502 are defined to a first depth and the second grooves 506 are defined to a second depth different than the first depth. Thus, the depth of the first and second grooves 502, 506 facilitates respective ones of the optical fibers 508, 510 overlaying one another at the intersections 512 between the first and second grooves 502, 506 and/or the first and second optical fibers 508, 510. In some examples, a depth of the first and/or second grooves 502, 506 is between about 4 micrometers and 50 micrometers. In some examples, the width of the first and/or second grooves 502, 506 is between about 4 micrometers and 70 micrometers. In some examples, the depth and/or width of the first and/or second grooves 502, 506 varies depending on whether the optical fibers 508 and/or 510 are single mold optical fibers or multi-mode multiple fibers.

In some examples, at least one of the intersections 512 between the first and second grooves 502, 506 is associated with a transceiver (e.g., the light source 116, the driver 118, the detector 120) 514. Thus, using the examples disclosed herein, a signal received at one of the transceivers 514 from one of the first and/or second optical fibers 508, 510 may cause the signal to be distributed and/or directed to another one of the transceivers 514 and/or may cause the signal to be distributed and/or directed in a different direction. In some examples, the grooves 502 and/or 506 in the molded substrate 126 are defined by post-mold mechanical removal processes (e.g., sawing, laser, etching, etc.). Additionally and/or alternatively, in some examples, the grooves 502 and/or 506 in the molded substrate 126 are defined during molding processes (e.g., lost wax material processes).

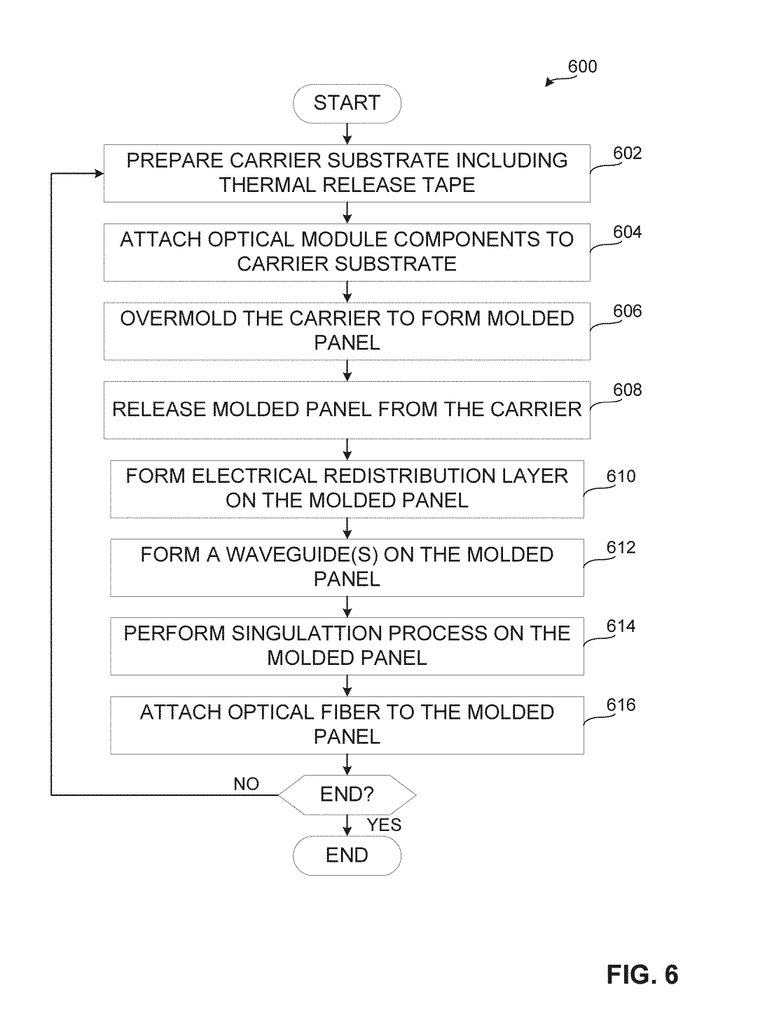

FIGS. 6, 8 and 9 depict example flow diagrams representative of processes that may be implemented using, for example, computer readable instructions that may be carried out in conjunction with optical module producing equipment and/or circuit producing equipment to produce the example optical modules 100, 300, 500 or any other of the examples described herein. The example processes of FIGS. 6, 8 and 9 may be performed using a processor, a controller and/or any other suitable processing device. For example, the example processes of FIGS. 6, 8 and 9 may be implemented using coded instructions (e.g., computer readable instructions) stored on a tangible computer readable medium such as a flash memory, a read-only memory (ROM), and/or a random-access memory (RAM). As used herein, the term tangible computer readable medium is expressly defined to include any type of computer readable storage and to exclude propagating signals. Additionally and/or alternatively, the example processes of FIGS. 6, 8 and 9 may be implemented using coded instructions (e.g., computer readable instructions) stored on a non-transitory computer readable medium such as a flash memory, a read-only memory (ROM), a random-access memory (RAM), a cache, or any other storage media in which information is stored for any duration (e.g., for extended time periods, permanently, brief instances, for temporarily buffering, and/or for caching of the information). As used herein, the term non-transitory computer readable medium is expressly defined to include any type of computer readable medium and to exclude propagating signals.

Alternatively, some or all of the example processes of FIGS. 6, 8 and 9 may be implemented using any combination(s) of application specific integrated circuit(s) (ASIC(s)), programmable logic device(s) (PLD(s)), field programmable logic device(s) (FPLD(s)), discrete logic, hardware, firmware, etc. Also, some or all of the example processes of FIGS. 6, 8 and 9 may be implemented manually or as any combination(s) of any of the foregoing techniques, for example, any combination of firmware, software, discrete logic and/or hardware. Further, although the example processes of figures FIGS. 6, 8 and 9 are described with reference to the flow diagram of FIGS. 6, 8 and 9, other methods of implementing the processes of FIGS. 6, 8 and 9 may be employed. For example, the order of execution of the blocks may be changed, and/or some of the blocks described may be changed, eliminated, sub-divided, or combined. Additionally, any or all of the example processes of FIGS. 6, 8 and 9 may be performed sequentially and/or in parallel by, for example, separate processing threads, processors, devices, discrete logic, circuits, etc.

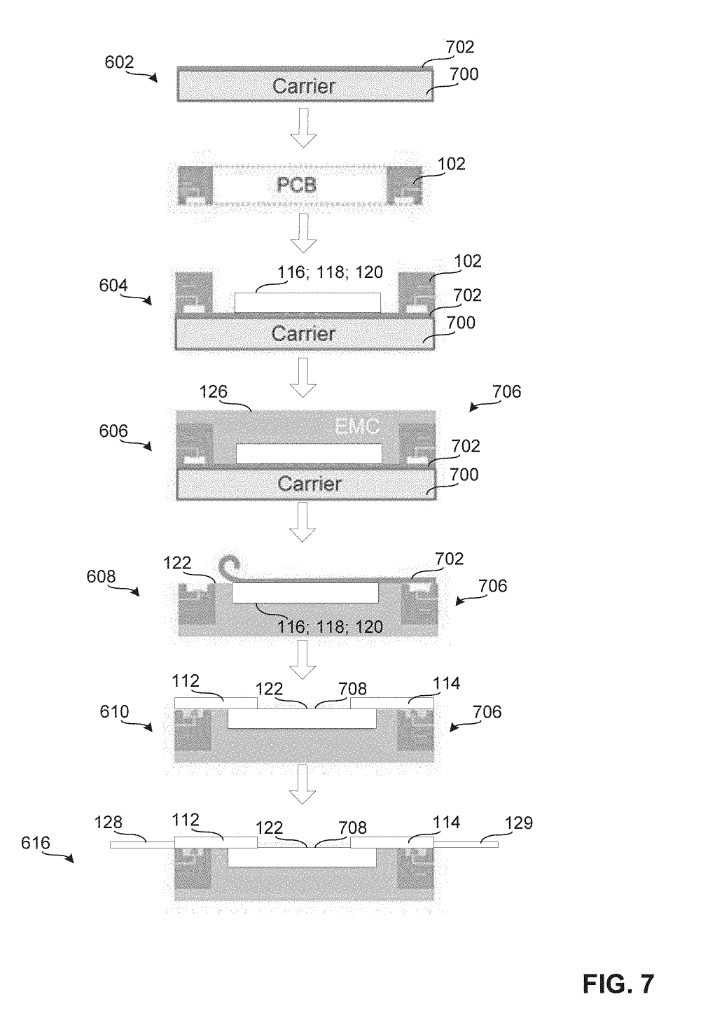

The method 600 of FIG. 6 will be described in combination with FIG. 7, which shows resulting structure from executing the process of FIG. 6. The method 600 begins by preparing a carrier substrate including thermal release tape (block 602) by, for example, providing a carrier substrate 700 (FIG. 7) and a thermal release tape 702 (FIG. 7). Optical module components (e.g., optoelectronic components) and/or a circuit are attached to the carrier substrate (block 604) by, for example, attaching the PCB 102, the CPU 104, the chip set 106, the memory 108, the light source 116, the driver 118 and/or the detector 120 to the thermal release tape 702 of the carrier 700 and/or coupling optoelectronic components to a carrier substrate.

The carrier is then overmolded to form a molded panel and/or substrate (block 606) by, for example, overmolding and/or substantially encapsulating the PCB 102, the CPU 104, the chip set 106, the memory 108, the light source 116, the driver 118 and/or the detector 120 with the overmold material 126 to form a molded panel 706 and/or overmolding the optoelectronic components with an overmolding material to form a molded panel and to enable a surface of the molded panel to be at least substantially flush. In some examples, the molded panel 706 is formed using a compression mold and/or compression molding processes.

The carrier is removed from the molded panel (block 608) by, for example, removing the thermal release tape 702 from the first surface 122 of the molded panel 706 and/or removing the carrier substrate from the surface. In some examples, an electrical redistribution layer is formed on the molded panel (block 610) by, for example, forming an electrical redistribution layer 708 on the first surface 122. In some examples, the electrical redistribution layer is used as an electrical interconnect.

Waveguides are formed on the molded panel (block 612) by for example, forming the first and/or second waveguides 112, 114 on and/or adjacent to the first surface 122 and/or by forming the first and/or second grooves 130, 131 on and/or adjacent to the first surface 122. In some examples, turning mirrors are disposed adjacent the wave guides 112, 114 that guide (e.g., tilts, turns) the light as the light enters the optical module 100.

In some examples, a singulation process is performed on the molded panel (block 614) to, for example, cut and/or size the molded panel into a smaller die size. An optical fiber is attached to the molded panel (block 616) by, for example, inserting and/or positioning the first optical fiber 128 within the first groove 130 and/or by positioning the second optical fiber 129 within the second groove 131.

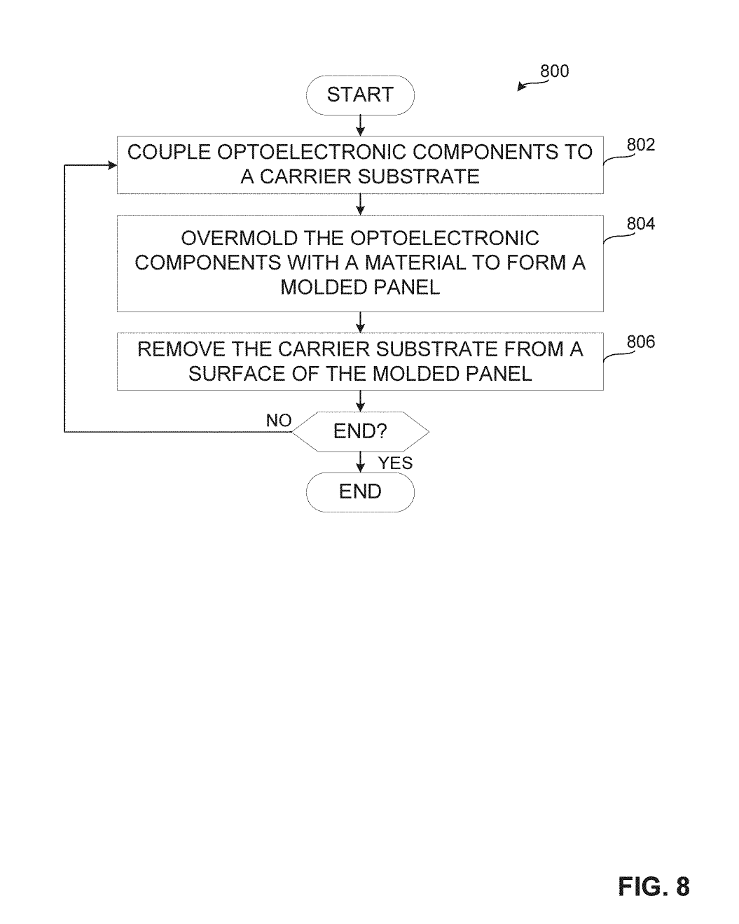

The method 800 of FIG. 8 begins by coupling optoelectronic components to a carrier substrate (block 802) by, for example, attaching the PCB 102, the CPU 104, the chip set 106, the memory 108, the light source 116, the driver 118 and/or the detector 120 to the thermal release tape 702 of the carrier 700 and/or coupling optoelectronic components to a carrier substrate. The optoelectronic components are overmolded with a material to form a molded panel (block 804) by, for example, overmolding and/or substantially encapsulating the PCB 102, the CPU 104, the chip set 106, the memory 108, the light source 116, the driver 118 and/or the detector 120 with the overmold material 126 to form a molded panel 706. The carrier substrate is removed from a surface of the molded panel (block 806) by, for example, removing the thermal release tape 702 from the first surface 122 of the molded panel 706 and/or removing the carrier substrate from the surface.

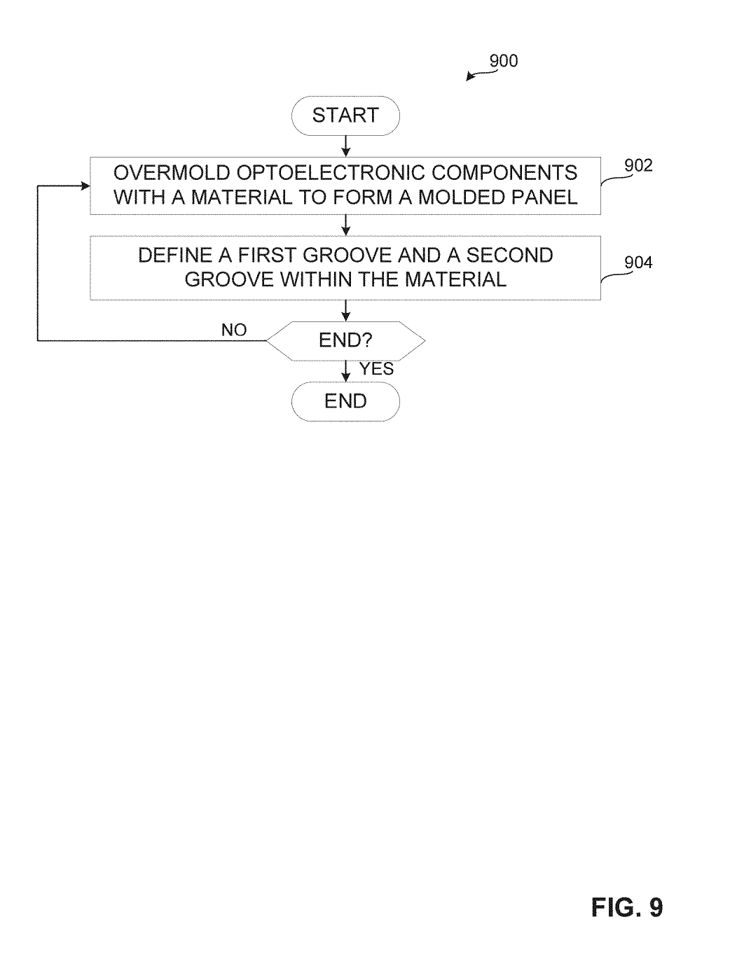

The method 900 of FIG. 9 begins by overmolding optoelectronic components with a material to form a molded panel (block 902) by, for example, overmolding and/or substantially encapsulating the PCB 102, the CPU 104, the chip set 106, the memory 108, the light source 116, the driver 118 and/or the detector 120 with the overmold material 126 to form a molded panel 706. First and second grooves are formed within the material (block 904) by, for example, defining the first and second grooves 502, 506 within the overmold material 126.

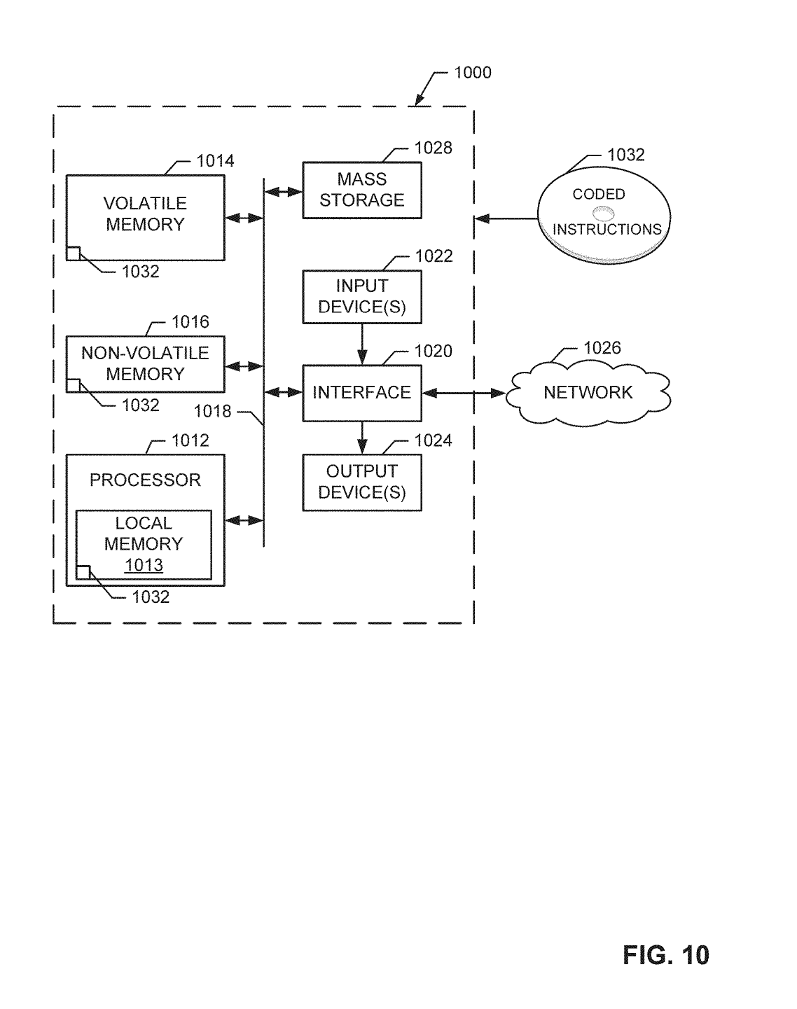

FIG. 10 is a block diagram of an example processor platform 1000 capable of executing the instructions of FIGS. 6, 7, 8 and 9 to implement an apparatus (e.g., fabrication equipment) to produce the example optical modules and/or the examples disclosed herein. The processor platform 1000 can be, for example, a server, a personal computer, a mobile device (e.g., a cell phone, a smart phone, a tablet such as an iPad™), a personal digital assistant (PDA), an Internet appliance, or any other type of computing device.

The processor platform 1000 of the illustrated example includes a processor 1012. The processor 1012 of the illustrated example is hardware. For example, the processor 1012 can be implemented by at least one of integrated circuits, logic circuits, microprocessors or controllers from any desired family or manufacturer.

The processor 1012 of the illustrated example includes a local memory 1013 (e.g., a cache). The processor 1012 of the illustrated example is in communication with a main memory including a volatile memory 1014 and a non-volatile memory 1016 via a bus 1018. The volatile memory 1014 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 816 may be implemented by flash memory and/or any other desired type of memory device. Access to the main memory 1014, 1016 is controlled by a memory controller.

The processor platform 1000 of the illustrated example also includes an interface circuit 1020. The interface circuit 1020 may be implemented by any type of interface standard, such as an Ethernet interface, a universal serial bus (USB), and/or a PCI express interface.

In the illustrated example, at least one of input devices 1022 are connected to the interface circuit 1020. The input device(s) 1022 permit(s) a user to enter data and commands into the processor 1012. The input device(s) can be implemented by, for example, an audio sensor, a microphone, (still or video), a keyboard, a button, a mouse, a touchscreen, a track-pad, a trackball, isopoint and/or a voice recognition system.

At least one of output devices 1024 is also connected to the interface circuit 1020 of the illustrated example. The output devices 1024 can be implemented, for example, by display devices (e.g., a light emitting diode (LED), an organic light emitting diode (OLED), a liquid crystal display, a cathode ray tube display (CRT), a touchscreen, a tactile output device, a light emitting diode (LED)). The interface circuit 1020 of the illustrated example, thus, typically includes a graphics driver card, a graphics driver chip or a graphics driver processor.

The interface circuit 1020 of the illustrated example may also include a communication device such as a transmitter, a receiver, a transceiver, a modem and/or network interface card to facilitate exchange of data with external machines (e.g., computing devices of any kind) via a network 1026 (e.g., an Ethernet connection, a digital subscriber line (DSL), a telephone line, coaxial cable, a cellular telephone system, etc.).

The processor platform 1000 of the illustrated example may also include at least one of mass storage devices 1028 for storing software and/or data. Examples of such mass storage devices 1028 include floppy disk drives, hard drive disks, compact disk drives, Blu-ray disk drives, RAID systems, and digital versatile disk (DVD) drives.

The coded instructions 1032 of FIGS. 6, 7, 8 and 9 may be stored in the mass storage device 1028, in the volatile memory 1014, in the non-volatile memory 1016, and/or on a removable tangible computer readable storage medium such as a CD or DVD.

From the foregoing, it will be appreciated that the above disclosed methods, apparatus and articles of manufacture relate to manufacturing example optical modules on example removable carriers to enable opposing surfaces of the optical module to be substantially parallel and/or co-planer or to enable the example optical modules to have at least one substantially planar surface. As set forth herein, substantially parallel means between about 3 degrees of parallel and/or accounts for manufacturing tolerances. As set forth herein, co-planer means about 3 degrees of being co-planer and/or accounts for manufacturing tolerances. As set forth herein, substantially planar accounts for manufacturing tolerances. In some example optical modules, different components are overmolded with epoxy. The components may include a PCB, an integrated circuit (IC), a photonic chip, etc. In some examples, grooves (e.g., a groove array to receive an optical fiber array) are defined in the epoxy to enable passive alignment and/or coupling (e.g., optical coupling) between optical fibers and the optical module and/or its optical circuits.

The examples disclosed herein relate to optical modules including a co-planar panel into which optoelectronic (OE) components are disposed to enable the optoelectronic components to be substantially flush with the panel and/or the wafer surface. Thus, using the examples disclosed herein, optoelectronic components are integrated into a molded package such that a surface (e.g., a top surface of at least one of the optoelectronic components) is substantially flush with the panel surface. As set forth herein, substantially flush accounts for manufacturing tolerances.

In some examples, the optoelectronic components include a VCSEL light source, a driver, a GaAs detector, receptacles, a PCB, a CPU, etc. that are overmolded on panel level. Providing a planer surface on the molded panel enables optoelectronic components to be electrically and/or optically coupled to reduce the complexity and/or cost of manufacturing the example optical modules disclosed herein. Using the examples disclosed herein, at least one waveguide can be built at panel level using photo equipment and/or the PCB and/or the RILL may be used as an electrical interconnect. In some examples, the waveguide is molded and/or defined using the overmolding material and/or epoxy.

To produce the example optical modules, in some examples, a VSCEL light source, a detector and/or other components are embedded into an overmolding material (e.g., epoxy) to form a molded panel, a waveguide(s) is fabricated on and/or across a surface of the molded panel and/or a turning mirror(s) is positioned adjacent the VSCEL light source. In some examples, the turning mirror guides (e.g., tilts, turns) the light as the light enters the substrate optical module. In some examples, optical fibers coupled to the example optical modules communicate with the photonic chip (e.g., the VSCEL light source) by microbending the light, by using a fiber coupler, etc.

In some examples, the optical module and/or the molded panel includes a vent(s) and/or a fluidic channel(s) defined therein to cool and/or reduce the temperature of the components (e.g., VSCEL light source) of the optical module. In some examples, providing cooling vents for the VSCEL light source improves the power conversion efficiency of the VSCEL light source and/or extends the useful life of the VSCEL light source.

As set forth herein, an optical module including optoelectronic components; and a material overmolding the optoelectronic components to form a molded panel, the molded panel having opposing at least substantially co planer surfaces to enable direct coupling thereto. In some examples, the optoelectronic components include at least one of a printed circuit board, an integrated circuit, a memory, a central processing unit, a chip set, a light source, and a detector. In some examples, the material includes epoxy. In some examples, the material defines a groove to receive an optical fiber, an interaction between the groove and the optical fiber to couple the optical fiber to the optoelectronic components. In some examples, the groove is a first groove and the optical fiber is a first optical fiber, further including a second groove defined by the material, the second groove to receive a second optical fiber, an interaction between the second groove and the second optical fiber to couple the second optical fiber to the optoelectronic components. In some examples, the first groove intersects the second groove, the first groove having a first depth and the second groove having a second depth, the first depth different than the second depth to enable one of the first optical fiber and the second optical fiber overlaying the other of the first optical fiber and the second optical fiber.

In some examples, the surface is a first surface, further including a second surface opposite the first surface, the first and second surfaces being at least substantially co-planer. In some examples, the optical module includes a heat sink coupled to the second surface. In some examples, the optical module includes an aperture defined by the material, the aperture to enable cooling of at least one of the optoelectronic components. In some example, the optical module includes a waveguide positioned adjacent the surface. In some examples, the optical module includes a lens on the first surface to tilt light entering the waveguide.

An example method includes coupling optoelectronic components to a carrier substrate; overmolding the optoelectronic components with an overmolding material to form a molded panel and to enable a surface of the molded panel to be at least substantially flush; and removing the carrier substrate from the surface. The method includes forming a groove in the overmoldling material, the groove to receive an optical fiber, an interaction between the groove and the optical fiber to couple the optical fiber and the optoelectronic components. In some examples, the groove includes a first groove, further including forming a second groove in the overmolding material, the first groove intersecting the second groove.

An example method includes overmolding optoelectronic components with a material to form a molded panel; and defining a first groove and a second groove within the material, the first groove intersecting the second groove, the first groove having a first depth and the second groove having a second depth to enable one of the first optical fiber and the second optical fiber overlaying the other of the first optical fiber and the second optical fiber.

An example method includes coupling optoelectronic components to a carrier substrate; overmolding the optoelectronic components with a material to form a molded panel, a surface of the molded panel to be at least substantially flush; and removing the carrier substrate from the surface. In some examples, the method includes forming a groove in the material and positioning an optical fiber within the groove, an interaction between the groove and the optical fiber to couple the optical fiber and the optoelectronic components.

In some examples, the method includes forming a first groove in the material and forming a second groove in the material, the first groove intersecting the second groove. In some examples, the method includes forming a first groove in the material having a first depth and forming a second groove in the material having a second depth, based on the first and second depths, one of a first optical fiber and a second optical fiber overlaying the other of the first optical fiber and the second optical fiber within the first and second grooves. In some examples, coupling the optoelectronic components to the carrier substrate includes coupling at least one of a printed circuit board, an integrated circuit, a memory, a central processing unit, a chip set, a light source, and a detector to the carrier substrate. In some examples, the surface is a first surface, further including coupling a heat sink to a second surface opposite the first surface. In some examples, the first and second surfaces are at least substantially co-planer. In some examples, the method includes forming an aperture in the material, the aperture to provide a vent for at least one of the optoelectronic components.

An example method includes overmolding optoelectronic components with a material to form a molded panel: and defining a first groove and a second groove within the material, the first groove intersecting the second groove, the first groove having a first depth and the second groove having a second depth, one of a first optical fiber and a second optical fiber overlaying the other of the first optical fiber and the second optical fiber within the first and second grooves. In some examples, prior to the overmolding optoelectronic components with the material, coupling the optoelectronic components to a carrier substrate. In some examples, the method includes, after overmolding optoelectronic components with the material, removing the carrier substrate. In some examples, coupling the optoelectronic components to the carrier substrate includes coupling at least one of a printed circuit board, an integrated circuit, a memory, a central processing unit a chip set, a light source, and a detector to the carrier substrate.

An example optical module includes optoelectronic components; and a material overmolding the optoelectronic components to form a molded panel, the molded panel having opposing at least substantially co-planer surfaces to provide coupling points directly thereto. In some examples, material defines a first groove to receive a first optical fiber and a second groove to receive a second optical fiber, an interaction between the first groove and the first optical fiber to couple the first optical fiber within the first groove, an interaction between the second groove and the second optical fiber to couple the second optical fiber within the second groove. In some examples, the first groove intersects the second groove, the first groove having a first depth and the second groove having a second depth, the first depth different than the second depth, one of the first optical fiber and the second optical fiber overlaying the other of the first optical fiber and the second optical fiber within the first and second grooves.

Although certain example methods, apparatus and articles of manufacture have been described herein, the scope of coverage of this patent is not limited thereto. On the contrary, this patent covers all methods, apparatus and articles of manufacture fairly falling within the scope of the claims of this patent.

What is claimed is:

1. A method, comprising:
coupling optoelectronic components to a carrier substrate;
overmolding the optoelectronic components with a material to form a molded panel, a surface of the molded panel to be at least substantially flush; and
removing the carrier substrate from the surface.

2. The method of claim 1, further including forming a groove in the material and positioning an optical fiber within the groove, an interaction between the groove and the optical fiber to couple the optical fiber and the optoelectronic components.

3. The method of claim 1, further including forming a first groove in the material and forming a second groove in the material, the first groove intersecting the second groove.

4. The method of claim 1, further including forming a first groove in the material having a first depth and forming a second groove in the material having a second depth, based on the first and second depths, one of a first optical fiber and a second optical fiber overlaying the other of the first optical fiber and the second optical fiber within the first and second grooves.

5. The method of claim 1, wherein coupling the optoelectronic components to the carrier substrate includes coupling at least one of a printed circuit board, an integrated circuit, a memory, a central processing unit, a chip set, a light source, and a detector to the carrier substrate.

6. The method of claim 1, wherein the surface is a first surface, further including coupling a heat sink to a second surface opposite the first surface.

7. The method of claim 6, wherein the first and second surfaces are at least substantially co-planer.

8. The method of claim 1, further including forming an aperture in the material, the aperture to provide a vent for at least one of the optoelectronic components.

9. An method, comprising:
overmolding optoelectronic components with a material to for a molded panel; and
defining a first groove and a second groove within the material, the first groove intersecting the second groove, the first groove having a first depth and the second groove having a second depth, one of a first optical fiber and a second optical fiber overlaying the other of the first optical fiber and the second optical fiber within the first and second grooves.

10. The method of claim 9, wherein, prior to the overmolding optoelectronic components with the material, coupling the optoelectronic components to a carrier substrate.

11. The method of claim 10, further including, after overmolding optoelectronic components with the material, removing the carrier substrate.

12. The method of claim 10, wherein coupling the optoelectronic components to the carrier substrate includes coupling at least one of a printed circuit board, an integrated circuit, a memory, a central processing unit, a chip set, a light source, and a detector to the carrier substrate.

13. An optical module, comprising:
optoelectronic components; and
a material overmolding the optoelectronic components to form a molded panel, the molded panel having opposing at least substantially co-planer surfaces to provide coupling points directly to the material.

14. The optical module of claim 13, wherein the material defines a first groove to receive a first optical fiber and a second groove to receive a second optical fiber, an interaction between the first groove and the first optical fiber to couple the first optical fiber within the first groove, an interaction between the second groove and the second optical fiber to couple the second optical fiber within the second groove.

15. The optical module of claim 14, wherein the first groove intersects the second groove, the first groove having a first depth and the second groove having a second depth, the first depth different than the second depth, one of the first optical fiber and the second optical fiber overlays the other of the first optical fiber and the second optical fiber within the first and second grooves.
